(19) United States
(12) Patent Application Publication
(10) Pub. No.: US 2018/0295044 A1
(43) Pub. Date: Oct. 11, 2018

(54) AUTOMATED MANAGEMENT OF SERVICE INSTANCES

(71) Applicant: LinkedIn Corporation, Sunnyvale, CA (US)

(72) Inventors: Jason R. Johnson, San Jose, CA (US); Steven C. Ihde, San Carlos, CA (US); Jingshu Xia, Cupertino, CA (US)

(73) Assignee: LinkedIn Corporation, Sunnyvale, CA (US)

(21) Appl. No.: 15/480,256

(22) Filed: Apr. 5, 2017

(51) Int. Cl. H04L 12/26; H04L 29/08

(52) U.S. Cl. CPC H04L 43/0894; H04L 67/101; H04L 43/16; H04L 67/1031

(57) ABSTRACT

A system, apparatus, and methods are provided for automatically managing a collection of service instances. A selected or random instance of the service isredline-tested to determine a maximum level of sustained and stable performance (e.g., a maximum or approximate maximum load or throughput of the service instance). This redline value may represent a highest service request rate (e.g., in queries per second or qps) that should be delivered to some or all instances of the service. An expected range of demand for the service is then estimated for a future time period, possibly from analysis and/or observations of past demand, and a maximum and minimum number of instances for handling that range of demand, at an acceptable level of performance, can be determined. During the time period, additional instances may be created and superfluous instances may be removed automatically, based on actual demand.

### BACKGROUND

This disclosure relates to computer systems. More particularly, a system, apparatus, and methods are provided for automatically managing instances of an online service.

Online services are widely available via the Internet, wide-area networks, and intranets. Typically, a host or provider of a service provisions the service to accommodate a maximum or peak expected demand for the service. For example, the provider may configure a number of computer systems (e.g., servers) and a number of instances of the service that should be able to handle the expected demand.

If the provider estimates incorrectly, however, and the actual demand exceeds the expected demand, some service users or customers will likely be disappointed in how the service performs for them. Contrarily, if the actual demand is significantly less than the expected demand, the provider will have wasted resources that were dedicated to the service and that may have been useful for some other service or other tasks.

### DESCRIPTION OF THE FIGURES

FIG. 1 is a block diagram depicting an environment in which a fleet or other collection of service instances is managed automatically, in accordance with some embodiments.

FIG. 2 is a flow chart illustrating a method of redline testing an online service or application, in accordance with some embodiments.

FIG. 3 is a flow chart illustrating a method of automatically managing a fleet or other collection of service instances, in accordance with some embodiments.

FIG. 4 depicts an apparatus for automatically managing a fleet or other collection of service instances, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, a system, apparatus, and methods are provided for automatically managing a fleet or other collection of instances of a service. In these embodiments, a selected instance of the service is redlined, meaning that its operation with live traffic is tested to identify the maximum load that the instance can handle in a stable manner, or the maximum throughput that it can handle without compromising performance, user experience, or availability. Based on a redline value associated with the service based on this testing, which may be expressed in queries per second (qps), and current demand for the service (e.g., incoming rate of service requests), new service instances are created when needed and existing instances are removed when they are no longer needed. Therefore, as the service's load ebbs and flows, the size of the fleet fluctuates accordingly.

In some implementations, redline testing of a selected service instance involves progressively increasing its share of live production traffic. For example, a load balancer or other system component that assigns new requests to available instances of the service may be programmed to revise a round-robin (or other) scheduling method to cause the selected instance to receive a greater and greater percentage of the service's total load.

After the selected service instance's load is increased by some increment (e.g., by some measure of qps, by some percentage of the service's total load), it can be monitored for a period of time to determine whether it handles the load stably. Stable handling of the load may involve processing the requests submitted to it without violating a service level agreement (SLA) or some other criterion or criteria. For example, the service's SLA or a temporary requirement applied during the testing may specify that some percentage of the total number of requests it processes (e.g., 90%, 95%, 99%) must be handled with some minimum (average) throughput or maximum response time. Testing may involve multiple increases in the service instance's load, with its performance being examined after each increase.

When an increase causes the selected instance to become unstable, the last increase may be rolled back and (if the instance is still stable at the previous load level) that load may be considered the maximum load that the selected instance can handle in a stable manner. If all instances of the service being tested are not substantially equivalent, such as if some instances execute on significantly more (or less) robust computing platforms, separate redline values may be determined for each type or class of service instance.

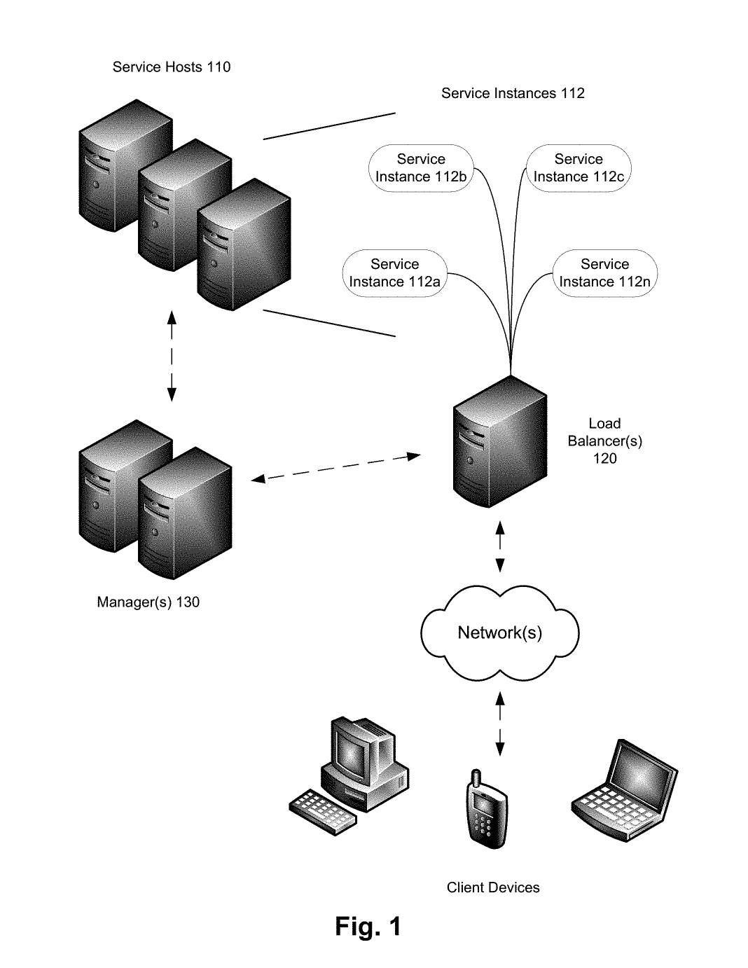

FIG. 1 is a block diagram depicting a computing environment in which a fleet or other collection of service instances is managed automatically, according to some embodiments.

The environment of FIG. 1 may be part of a data center, a computer room, or other cooperative collection of computing equipment. Alternatively, different components shown in FIG. 1 may reside and operate remote from each other. In this environment, service hosts 110 are computing platforms (e.g., servers, blades) that host service instances 112, which are instances of a computer service. The n illustrated service instances (instances 112a-112n) are distributed among m service hosts (m, n≥1).

One or more load balancers 120 distribute requests for the service among the n instances, according to a round-robin scheme or some other scheduling technique. At least some service requests delivered to service instances 112 originate from client devices. Requests for the service, whether issued directly from a client device or from an application or service acting on behalf of a client request or a system call unassociated with any client request, may traverse one or more networks (e.g., the Internet, an intranet, a local area network) and/or one or more intermediate computer systems (e.g., a portal, a front-end server) before arriving at load balancer(s) 120 and service instances 112.

One or more manager nodes or platforms 130 interact with load balancer(s) 120 during redline testing to adjust the load-balancing scheme to concentrate the service's load on one or more selected service instances (and therefore possibly decrease the load on other instances). The manager nodes also communicate with service hosts 110 to create/remove service instances, to determine the loads placed on service instances and/or the hosts, to determine whether a service host is stable, and/or for other purposes. A manager node or platform may also (or instead) receive status data directly from a service instance.

A manager node (or some other entity) monitors the performance of the service instances, during redline testing and during normal operation of the service, to determine whether an instance that is being redlined has become unstable, to determine whether a service instance is approaching a redline value or some other threshold level of load/throughput, to calculate an average load/throughput of the active service instances, etc.

In some embodiments, the monitoring of service instances during live execution of the service (e.g., to determine their average loads, to determine whether to add or remove a service instance), and/or a determination of whether a service instance being redlined (or redline-tested) has become unstable, includes examining time-series metrics output by the instance or instances and comparing them to baseline metrics indicative of a healthy (or unhealthy) instance. Besides qps, stability may be measured or estimated using request error rate, CPU utilization, memory utilization, threadpool utilization, network drops, TCP (Transmission Control Protocol) listen overflow, and/or some other metric(s).

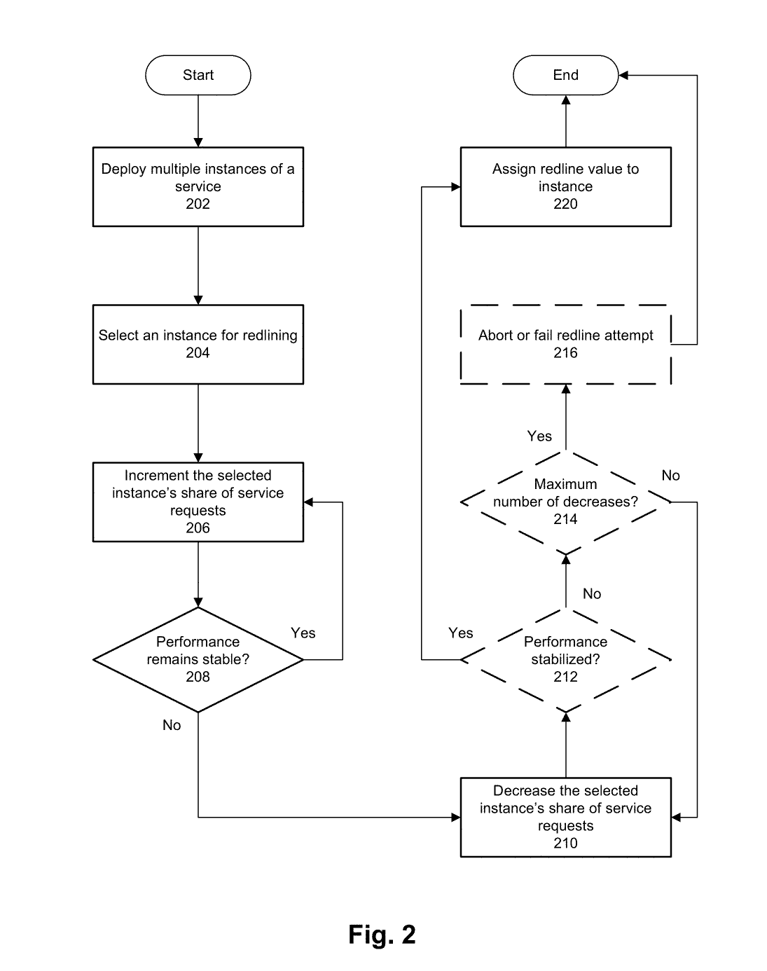

FIG. 2 is a flow chart illustrating a method of redline testing an online service or application, according to some embodiments. In one or more embodiments, one or more of the indicated operations may be omitted, repeated, and/or performed in a different order. Accordingly, the specific arrangement of operations shown in FIG. 2 should not be construed as limiting the scope of the embodiments described herein.

In some implementations, redlining may be performed for a service once, multiple times, or on a regular/periodic/scheduled basis. For example, the service may be redlined at different times of day, on different days, etc. Each time the service is redlined, a redline value is produced. Multiple redline values from different iterations of testing may be combined (e.g., to obtain an average), or the results may be used to manage a collection of service instances differently over time. As discussed further below, for example, the service's redline value may affect the number of service instances deployed at a given time, and different redline values may be employed at different times.

In operation 202, multiple instances of a service (or application) are deployed and used to handle live production traffic (e.g., requests initiated by clients of the service or by an online application that comprises the service). Initially, the service's load may be distributed evenly, or approximately evenly, among the service instances, meaning that each instance receives a load that is approximately equal to the loads placed on the other instances.

In operation 204, one of the service instances is selected for redline testing. If all services are not substantially similar, meaning that they execute on similarly configured hosts and have access to similar amounts or types of resources, multiple service instances may be selected for redlining, such as one instance of each class of instance, wherein a service instance's class is determined by its (or its host's) configuration.

In operation 206, the load on the selected service instance (e.g., number or rate of arrival of service requests (qps)) is incremented. For example, if there are 11 active instances of the service, and each instance initially handles approximately 9% of the service's traffic, a scheduling or load-balancing technique may be adjusted to decrease the traffic to 10 of the instances (the non-selected instances) by approximately ½ of 1 percentage point, so that the selected instance now receives approximately 14% of the total traffic. In this example, one out of every 200 hundred requests that would normally be directed to one of the other service instances could instead be delivered to the selected instance. In some other embodiments, a metric other than qps may be used to perform redline testing (e.g., to determine the load on a service instance, to determine whether its performance is stable), such as some measure of latency, for example.

In operation 208, the selected service instance's performance is observed over some period of time (e.g., one minute, thirty seconds, one second) to determine if it can handle the increased load without becoming unstable. If, for example, the instance can handle the increased traffic without violating a term of a service level agreement associated with the service, or without exhibiting a metric (e.g., latency, response time) that is unacceptable, the instance is deemed capable of stably handling the current load. If the service instance's performance is stable, the method returns to operation 206 to further increase the load. If, however, the selected service instance becomes unstable at the current rate of requests, the method advances to operation 210.

In operation 210, the load on the selected instance is decreased. For example, the last increase to the instance's load may be undone, or the instance's current load may be decreased less than (or more than) the last increment. In some implementations, if the decrease in load is equal to or greater than the last increment, it may be assumed that the selected service instance can stably handle the lower level of demand.

In optional operation 212, the selected instance's ability to stably process the lower level of demand is tested or verified, possibly in the same manner as in operation 208 (e.g., by examining metrics produced by the service instance). This optional operation may be desirable if the decrease in traffic submitted to the instance in operation 210 is less than the previous increase. As already discussed, a goal is to identify a throughput or level of demand that the selected service instance is able to sustain. If the instance's performance is stable, the method advances to operation 220; otherwise it proceeds to operation 214.

In optional operation 214, if a maximum number of decrements or decreases has been set for the process of finding stability in the service instance's performance (e.g., 1, 3, 5), a determination is made as to whether that maximum has been reached. If so, the method proceeds to operation 216; otherwise the method returns to operation 210. Depending on the level of precision desired, operations 210-214 may be repeated one or more times before a maximum level of throughput, demand, or load that the selected service instance can stably handle is identified.

In optional operation 216, because the maximum number of downward adjustments has been applied to the selected instance's share of service requests without encountering stability, the current process of redline testing is aborted. It may be restarted immediately or at some other future time.

In operation 220, the current throughput, load, or demand on the selected instance is adopted as the redline value or redline number of the instance. For example, the highest observed request rate that the selected instance incurred and handled in a stable manner may be adopted as the redline value, which may be expressed in queries per second (qps). Other measures/metrics may be employed in other embodiments. Also, in some embodiments, a redline value may comprise a range of values instead of a single value, either in queries per second or some other metric.

The redline value of the tested service instance may also be adopted as the redline value of the service, particularly if all instances are substantially similar. If there are multiple types or classes of service instance, redline values of selected instances of each type may be aggregated to obtain a redline value for the service. For example, each instance of the service can be characterized by the redline value of the selected instance of the same type, and then the average redline value among all instances can be calculated.

In some embodiments, the examination as to whether the selected service instance can stably handle an increased level of demand (e.g., during redline testing) may be performed by a specialized application or service that observes metrics of target processes (such as the selected service instance) and identifies irregularities, which may operate on a manager node, a host platform, or some other computing device.

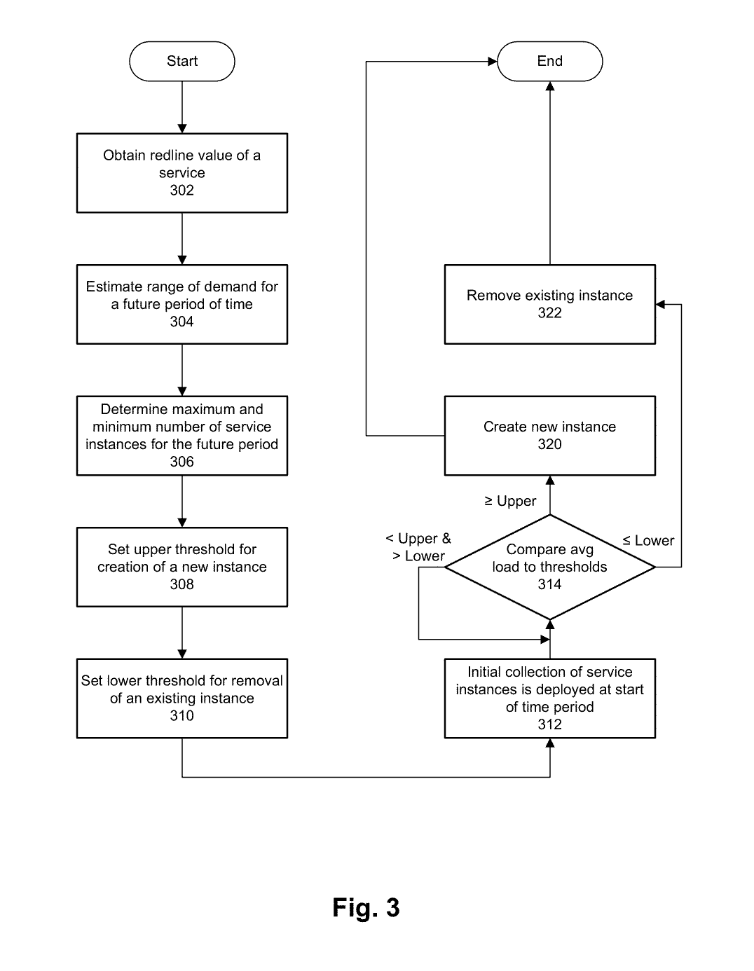

FIG. 3 is a flow chart illustrating a method of automatically managing a fleet or other collection of service instances, according to some embodiments. In one or more embodiments, one or more of the indicated operations may be omitted, repeated, and/or performed in a different order. Accordingly, the specific arrangement of operations shown in FIG. 3 should not be construed as limiting the scope of the embodiments described herein.

In operation 302, a redline value of a service is determined, possibly via a process described in conjunction with FIG. 2.

In operation 304, a range of demand for the service during a future period is estimated, in terms of lowest expected rate of request and highest expected rate of request (e.g., in qps), for example. The future period may encompass an hour, multiple hours, a day, multiple days, a week, or some other time period.

In some implementations, the future demand is estimated based on demand for the service observed during one or more past periods of time. For example, if demand for the service is cyclic, with each week exhibiting approximately the same pattern of demand as a previous week, then one or more previous weeks of observed traffic may be analyzed or copied to yield an estimated range of demand for a future week. Time durations other than one week may be used in other implementations (e.g., day, month).

In operation 306, minimum and/or maximum numbers of instances of the service to be deployed for the future period of time are determined. For example, based on the service's redline value (i.e., assuming that each instance can successfully service the rate of requests indicated by the redline value), the number of service instances necessary to handle the maximum expected demand may be adopted as the maximum number of instances to deploy, while the lowest number of service instances able to stably handle the minimum expected demand may be adopted as the minimum number of instances to deploy.

Thus, if Dₘᵢₙ and Dₘₐₓ are the minimum and maximum levels of demand expected for the service during the future period of time (e.g., expressed in qps), and R is the redline value of the service, Iₘᵢₙ and Iₘₐₓ (the minimum and maximum number of instances of the service needed during the future time period) can be calculated as:

$$Imin = \frac{Dmin}{R} and Im ax = \frac{Dmax}{R}$$

As described above, different types or classes of instances of the service may have different redline values, in which case some additional computation may be required to determine the maximum and minimum numbers of each type/class of instance that may be required during the target time period.

In operation 308, an upper load threshold is set that determines when a new instance of the service should be created or put into use. During execution of the service, the average throughput of the service instances, or the average rate of requests delivered to them, or some other relevant measure of their average load, will be continually or regularly calculated and compared to this upper threshold. Whenever the average measure of their load meets (or exceeds) the threshold, a new instance is created or put into use.

Illustratively, the upper load threshold may be a significant percentage of the service's redline value. Thus, if the redline value is 1,000 qps, the upper threshold may be on the order of 800 qps or 900 qps.

The average measure of the instances' loads may be required to remain at or above the upper threshold for some length of time (e.g., one second), some number of requests (e.g., 1,000), or some number of comparisons (e.g., 3), before the new instance is created or before it starts receiving service requests. If creation of a new instance takes a significant period of time (e.g., 30 seconds, 1 minute, multiple minutes), the upper threshold may be lower than it would be otherwise, and/or a service instance may be created and held in stand-by (i.e., without receiving service requests) when the average measure of load exceeds a different threshold (e.g., 750 qps), and then put into use immediately when the upper threshold is reached or deleted if the average load measure decreases below the different threshold. Normally, the number of service instances cannot exceed the maximum specified in operation 306.

In operation 310, a lower load threshold is set that determines when one or more instances of the service should be removed (e.g., deleted). During execution of the service, the average measure of the instances' load will be continually or regularly compared to this lower threshold. Whenever the average measure of their load meets (or falls below) the threshold, at least one instance is removed.

Illustratively, the lower load threshold may be a small percentage of the service's redline value. Thus, if the redline value is 1,000 qps, the lower threshold may be on the order of 100 qps or 150 qps. The average measure of the instances' loads may be required to remain at or below the lower threshold for some length of time (e.g., one second), some number of requests (e.g., 500), or some number of comparisons (e.g., 3), before an instance is removed. Normally, the number of service instances cannot fall below the minimum specified in operation 306.

In operation 312, at the start of the (future) period of time, the minimum number of service instances is deployed, or some other quantity—such as the average of the minimum and maximum, or the minimum number of instances necessary to stably handle the level of demand for the service experienced immediately before the start of the time period.

In operation 314, the average load of the service instances is compared to the upper and lower thresholds. If the average load is above the upper threshold, the method advances to operation 320. If the average load is below the lower threshold, the method advances to operation 322. If the average load is between the upper and lower thresholds, the comparison is performed again (e.g., after some delay, according to some schedule).

In some embodiments, the computing platforms that host the service instances monitor their loads, performance and/or other criteria, and report that information to a manager node. Alternatively, the service instances may report their statuses directly to the manager node. The manager node can then compute their average loads and compare that average to the upper and lower thresholds associated with the service.

In operation 320, as long as the current number of active instances of the service is below the maximum permitted, a new instance of the service is deployed or is put into use if one was in a stand-by or inactive mode. In some embodiments, if it is determined that a new instance is needed, but the maximum number of instances is already active, an alert may be issued to an operator or an additional instance may be created regardless. Illustratively, an extra instance may be permitted for a limited duration of time, or some overage may be permitted (e.g., as some percentage of the maximum specified number of instances).

In operation 322, as long as the current number of active instances of the service is above the minimum required, an existing instance of the service is torn down and removed from the collection of the service's instances.

After operation 320 or 322, the method ends or returns to operation 314 to continue monitoring the active service instances.

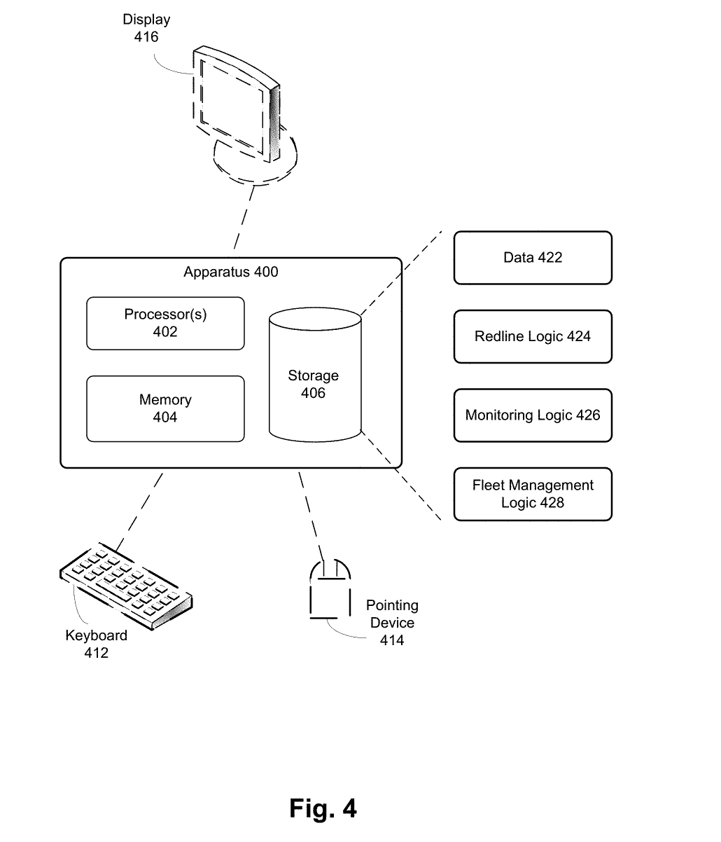

FIG. 4 depicts an apparatus for automatically managing a fleet or other collection of service instances, according to some embodiments. The apparatus may manage a fleet of service instances for any number of services (i.e., one or more).

Apparatus 400 of FIG. 4 includes processor(s) 402, memory 404, and storage 406, which may comprise any number of solid-state, magnetic, optical, and/or other types of storage components or devices. Storage 406 may be local to or remote from the apparatus. Apparatus 400 may be coupled (permanently or temporarily) to keyboard 412, pointing device 414, and display 416.

Storage 406 stores data 422 used by the apparatus, including (but not necessarily limited to) redline values, historical measures of demand, estimated demand levels for one or more time periods (e.g., minimum, maximum), minimum and maximum numbers of instances to deploy during a time period, and upper and lower thresholds for increasing and decreasing the fleet size.

Storage 406 also stores logic and/or logic modules that may be loaded into memory 404 for execution by processor(s) 402, including redline logic 424, monitoring logic 426, and fleet management logic 428. In other embodiments, logic modules may be aggregated or further divided to combine or separate functionality as desired or as appropriate.

Redline logic 424 comprises processor-executable instructions for determining a redline value for a service. As described above, the logic may cause a selected service instance's load to increase in steps, with its performance examine after each increase to determine if handles the load without becoming unstable. Eventually, logic 424 identifies a redline value representing a maximum (or approximately maximum) throughput or load that the instance can stably process.

Monitoring logic 426 comprises processor-executable instructions for monitoring performances of service instances. The monitoring logic may therefore consume various time-series data reflecting any relevant metrics of the instances (e.g., throughput, latency, response time). Logic 426 may therefore be used to determine, during redlining of a service instance, whether the instance is still stable after its load is increased.

Fleet management logic 428 comprises processor-executable instructions for managing a fleet or collection of instances of a given service (or multiple fleets different services' instances). As a service's instances execute, the fleet management logic determines whether their average throughput or load surpasses (or meets) an upper threshold or falls below (or to) a lower threshold, or is alerted when such a condition is detected (e.g., by monitoring logic 426). Another instance of the service may be created when the upper threshold is surpassed, or an existing instance may be removed when the lower threshold is crossed.

Apparatus 400 may perform some or all of the functionality attributed to manager nodes 130 in the environment depicted in FIG. 1.

An environment in which one or more embodiments described above are executed may incorporate a data center, a general-purpose computer or a special-purpose device such as a hand-held computer or communication device. Details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Any data structures and/or program code that may be employed in embodiments described above are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A computer-implemented method of managing a collection of instances of a service, the method comprising:
determining a maximum request rate at which a selected instance of the service provides a stable level of performance;
estimating a range of request rates to be received by the service during a future period of time; and
during the period of time, operating a computer to:
when an average request rate at the service instances is above a first threshold, automatically create an additional instance of the service; and
when the average request rate at the service instances is below a second threshold, automatically remove at least one instance of the service.

2. The method of claim 1, wherein said determining the maximum request rate at which the selected service instance provides a stable level of performance comprises:
(a) identifying a current rate of requests received at the selected service instance;
(b) determining whether the performance of the selected service instance is stable; and
(c) when the performance of the selected service instance is stable:
(c1) increasing the rate of requests received at the service instance; and
(c2) repeating (b)-(c).

3. The method of claim 2, wherein said determining the maximum request rate at which the selected service instance provides a stable level of performance further comprises:
(d) when the performance of the service instance is not stable:
(d1) reducing the rate of requests received at the service instance; and
(d2) determining whether the performance of the service instance is stable.

4. The method of claim 2, wherein said increasing the rate of requests received at the service instance comprises:
modifying a scheme for distributing service requests among multiple instances of the service, including the selected service instance, by decreasing a rate of requests received at one or more of the service instances other than the selected service instance.

5. The method of claim 1, further comprising:
based on said maximum request rate and said estimated range of request rates, calculating:
a minimum number of instances of the service for handling an estimated lowest request rate during the future period of time; and
a maximum number of instances of the service for handling an estimated highest request rate during the future period of time.

6. The method of claim 5, wherein:
automatically creating an additional instance of the service comprises creating the additional instance only if a current number of instances of the service is less than the maximum number of instances; and
automatically removing at least one instance of the service comprises removing the instance only if the current number of instances of the service is greater than the minimum number of instances.

7. The method of claim 1, further comprising:
determining a second maximum request rate at which a second selected instance of the service provides a stable level of performance, wherein a configuration of the second selected instance is different from a configuration of the selected instance of the service; and
combining the maximum request rate and the second maximum request rate.

8. An apparatus, comprising:
at least one processor; and
memory storing instructions that, when executed by the at least one processor, cause the apparatus to:
determine a maximum request rate at which a selected instance of the service provides a stable level of performance;
estimate a range of request rates to be received by the service during a future period of time; and
during the period of time:
when an average request rate at the service instances is above a first threshold, automatically create an additional instance of the service; and
when the average request rate at the service instances is below a second threshold, automatically remove at least one instance of the service.

9. The apparatus of claim 8, wherein said determining the maximum request rate at which the selected service instance provides a stable level of performance comprises:
(a) identifying a current rate of requests received at the selected service instance;
(b) determining whether the performance of the selected service instance is stable; and
(c) when the performance of the selected service instance is stable:
(c1) increasing the rate of requests received at the service instance; and
(c2) repeating (b)-(c).

10. The apparatus of claim 9, wherein said determining the maximum request rate at which the selected service instance provides a stable level of performance further comprises:
(d) when the performance of the service instance is not stable:
(d1) reducing the rate of requests received at the service instance; and
(d2) determining whether the performance of the service instance is stable.

11. The apparatus of claim 9, wherein said increasing the rate of requests received at the service instance comprises:
modifying a scheme for distributing service requests among multiple instances of the service, including the selected service instance, by decreasing a rate of requests received at one or more of the service instances other than the selected service instance.

12. The apparatus of claim 8, wherein the memory further stores instructions that, when executed by the at least one processor, cause the apparatus to:
based on said maximum request rate and said estimated range of request rates, calculating:
a minimum number of instances of the service for handling an estimated lowest request rate during the future period of time; and
a maximum number of instances of the service for handling an estimated highest request rate during the future period of time.

13. The apparatus of claim 12, wherein:
automatically creating an additional instance of the service comprises creating the additional instance only if a current number of instances of the service is less than the maximum number of instances; and
automatically removing at least one instance of the service comprises removing the instance only if the current number of instances of the service is greater than the minimum number of instances.

14. The apparatus of claim 8, wherein the memory further stores instructions that, when executed by the at least one processor, cause the apparatus to:
determine a second maximum request rate at which a second selected instance of the service provides a stable level of performance, wherein a configuration of the second selected instance is different from a configuration of the selected instance of the service; and
combine the maximum request rate and the second maximum request rate.

15. A system for managing a collection of instances of a service, comprising:
one or more processors;
a redline module comprising a non-transitory computer readable medium storing instructions that, when executed, cause the system to determine a maximum request rate at which a selected instance of the service provides a stable level of performance; and
a fleet management module comprising a non-transitory computer readable medium storing instructions that, when executed, cause the system to:
estimate a range of request rates to be received by the service during a future period of time; and
during the period of time:
when an average request rate at the service instances is above a first threshold, automatically create an additional instance of the service; and
when the average request rate at the service instances is below a second threshold, automatically remove at least one instance of the service.

16. The system of claim 15, wherein determining the maximum request rate at which the selected service instance provides a stable level of performance comprises:
(a) identifying a current rate of requests received at the selected service instance;
(b) determining whether the performance of the selected service instance is stable; and
(c) when the performance of the selected service instance is stable:
(c1) increasing the rate of requests received at the service instance; and
(c2) repeating (b)-(c).

17. The system of claim 16, wherein determining the maximum request rate at which the selected service instance provides a stable level of performance further comprises:
(d) when the performance of the service instance is not stable:
(d1) reducing the rate of requests received at the service instance; and
(d2) determining whether the performance of the service instance is stable.

18. The system of claim 16, wherein increasing the rate of requests received at the service instance comprises:
modifying a scheme for distributing service requests among multiple instances of the service, including the selected service instance, by decreasing a rate of requests received at one or more of the service instances other than the selected service instance.

19. The system of claim 15, wherein the non-transitory computer readable medium of the fleet management module further stores instructions that, when executed, cause the system to:
based on said maximum request rate and said estimated range of request rates, calculate:
a minimum number of instances of the service for handling an estimated lowest request rate during the future period of time; and
a maximum number of instances of the service for handling an estimated highest request rate during the future period of time.

20. The system of claim 19, wherein:
automatically creating an additional instance of the service comprises creating the additional instance only if a current number of instances of the service is less than the maximum number of instances; and
automatically removing at least one instance of the service comprises removing the instance only if the current number of instances of the service is greater than the minimum number of instances.
